(19) United States
(12) Patent Application Publication
(10) Pub. No.: US 2014/0067522 A1
(43) Pub. Date: Mar. 6, 2014

(54) METHOD AND SYSTEM FOR MANAGING ONLINE PAID ADVERTISEMENTS

(71) Applicant: SOKRATI TECHNOLOGIES PVT LTD, Pune (IN)

(72) Inventors: ASHISH MEHTA, PUNE (IN); APOORVA PATKAR, PUNE (IN); RAHUL KULKARNI, PUNE (IN); KUNAL PAREKH, PUNE (IN); SANTOSH GANNAVARAPU, PUNE (IN)

(73) Assignee: SOKRATI TECHNOLOGIES PVT LTD, Pune (IN)

(21) Appl. No.: 14/012,697

(22) Filed: Aug. 28, 2013

(30) Foreign Application Priority Data
Sep. 1, 2012 (IN) 2227/MUM/2012

(51) Int. Cl. G06Q 30/02

(52) U.S. Cl. CPC G06Q 30/0244
USPC 705/14.43

(57) ABSTRACT

The various embodiments of the present disclosure provide a method and system for managing a plurality of advertisements. The method comprises registering a plurality of users for an advertisement management application, retrieving information on one or more advertisements from the user, downloading an application tool from an application server; installing the application tool on a user device, accessing one or more advertisement accounts of at least one user, displaying a plurality of details of the one or more advertisements, providing a plurality of suggestions for the one or more advertisements and performing one or more actions on the advertisements from the plurality of suggestions based on a user requirement. The one or more actions herein includes creating new advertisements, modifying display characteristics of the existing advertisements, reviewing performance details of the advertisement, modifying the advertisement content and modifying the advertisement characteristics according to the suggestions.

### CROSS-REFERENCE TO RELATED APPLICATION

The present application claims priority of the Indian provisional application serial number 2227/MUM/2012 filed on Sep. 1, 2012, and that application is incorporated in its entirety at least by reference.

### BACKGROUND

1. Technical Field

The embodiments herein generally relate to advertising methods and systems and particularly relates to a method for online paid advertising. The embodiments herein more particularly relate to method and system for monitoring performance and managing online paid advertisements.

2. Description of the Related Art

Online advertising is a form of promotion that uses the Internet and World Wide Web to deliver marketing messages to attract customers. Generally, Pay-Per-Click (PPC) or online paid advertisement is an Internet advertising model used to direct traffic to websites, where advertisers pay the publisher when the ad is clicked. One major benefit of online advertising is the immediate publishing of information and content that is not limited by geography or time. Another benefit is the efficiency of advertiser's investment. Online advertising also provides for the customization of advertisements, including content and posted websites. For example, AdWords, Yahoo! Search Marketing and Google AdSense enable ads to be shown on relevant web pages or alongside search result.

With search engines, advertisers typically bid on keyword phrases relevant to their target market. PPC display advertisements are shown on search engine results with related content who have agreed to display the advertisements. The popular PPC providers include online paid marketing channels such as Google Adwords, Facebook Ads, Bing Adcenter, LinkedIn Ads, Twitter Ads, Display Ad Networks and the like.

It is most intuitive for one to think about an advertisement or improvisation of features when a user (advertiser) is actually looking at that advertisement. However, when the user has any ideas looking at actual Ad (say on Google.com or Facebook.com), the user has to either contact his agency or marketing team; who will then use a separate interface specific for that channel to make respective changes.

However, it is cumbersome for one to manage advertising campaigns on different channels as each channel has their respective interfaces and complicated account structure. Further it takes a lot of time for one to review each and every Ad and make optimal changes as these Ads could run into several seconds and requires manual effort to ensure optimal ads are being exposed to the users.

Typically, the performance changes due to new/edited Ads are very difficult to analyze with the existing tools. Also the existing tools restrict the viewers to provide necessary suggestions. The existing tools are limited in providing tools to modify the advertisement details.

In the view of foregoing, there is a need for a method and system for managing one or more online paid advertisements efficiently with less complexity. Also there is a need for a method and system to modify the advertisement contents/features in accordance with the user preferences. Further, there is a need for a method and system to measure performance of one or more online paid advertisements simultaneously.

The abovementioned shortcomings, disadvantages and problems are addressed herein and which will be understood by reading and studying the following specification.

### SUMMARY

The primary object of the present disclosure is to provide a method and system for simultaneously managing a plurality of online advertisements.

Another object of the present disclosure is to provide a method and system for monitoring, managing, editing and delivering a plurality of online advertisements.

Another object of the present disclosure is to provide a method and system which enables a user to search for the advertisements and see the place where the advertisement is live.

Another object of the present disclosure is to provide a method and system for facilitating easier navigation through a plurality of online advertisements.

Another object of the present disclosure is to provide a method and system for tracking the performance of a plurality of online advertisements.

Another object of the present disclosure is to provide a method and system for facilitating a plurality of user controlled options for managing the advertisement details and performance details of the advertisements.

Another object of the present disclosure is to provide a method and system for enabling third party individuals to provide suggestions on the posted advertisements.

Another object of the present disclosure is to provide a method and system for optimizing time and effort in reviewing and making the changes for a plurality of online advertisements.

Another object of the present disclosure is to provide a method and system to analyze the relative performance of an advertisement in comparison with a plurality of other advertisements of the same category.

The various embodiments herein provide a method and system for managing a plurality of online paid advertisements. The method of managing advertisements comprises steps of registering a plurality of users for an advertisement management application, retrieving information on one or more advertisements from the user, downloading an application tool from an application server and installing the application tool on a user device. The method further comprises accessing one or more advertisement accounts of at least one user, displaying a plurality of details of the one or more advertisements, providing a plurality of suggestions for the one or more advertisements and performing one or more actions on the advertisements from the plurality of suggestions based on a user requirement. The one or more actions includes creating new advertisements, modifying display characteristics of the existing advertisements, reviewing performance details of the advertisement, modifying the advertisement content and modifying the advertisement characteristics according to the suggestions.

According to an embodiment herein, registering to an application server comprises steps of providing a plurality of user credentials, creating a log-in account, providing details of existing advertisement accounts and creating a new advertisement account with at least one marketing channel. The user credentials include a name of the user, an email id and a password for authenticating the user onto the application server.

According to an embodiment herein, the user is at least one of a user owning a single advertisement account, a user owning multiple advertisement accounts or an enterprise owning multiple advertisement accounts. Here the plurality of advertisements includes at least one of Google Adwords, Facebook Ads, Bing Adcenter, LinkedIn Ads, Twitter Ads and Display Ad Networks, where the advertisements is in the form of graphical ads comprising banner ads, text only ads, image ads, video ads, audio ads and a combination thereof.

According to an embodiment herein, the application tool is one of a plug-in tool adapted to be installed on any web browser on the user device or any application installed in the user device.

According to an embodiment herein, the plurality of details of the online paid advertisement is displayed in the form of a task bar provided by the application tool. The plurality of details of the online paid advertisement is at least one of an advertisement name, number of clicks and performance of the advertisement.

According to an embodiment herein, the plurality of suggestions provided by the application tool comprises at least one of modification of advertisement details, modification of advertisement display characteristics, inclusion of additional information for the advertisements, inclusion of new advertisements, inclusion of attractive vocabularies, inclusion of attractive slides, inclusion of multilingual information, multicasting the advertisements over frequently visited websites, payment options for the user and a plurality of the other suggestions pertaining to the advertisement details and the performance details.

According to an embodiment herein, the method of managing a plurality of online advertisements further comprises registering one or more third party users with the application server, obtaining one or more suggestions from the third party users to enhance the performance of the advertisements and modifying a plurality of advertisement details, a plurality of display characteristics and additional information related to the advertisements by the user based on the suggestions.

According to an embodiment herein, the display characteristics comprises display color, intensity of the display color, slide show of the advertisement display, display area for the advertisement and a plurality of display modifying options depending upon the user's preferences.

According to an embodiment herein, managing the plurality of advertisements using the application tool comprises logging onto the application server, requesting an access to one or more advertisement accounts of at least one user, accessing a plurality of ad accounts by authorizing a corresponding marketing channel, displaying a plurality of details of an online paid advertisement and displaying an alert for newly obtained suggestions from one or more third party individuals. Also the plurality of details of the online paid advertisement is displayed in the form of a task bar provided by the application tool.

According to an embodiment herein, the plurality of user accounts is created in at least one marketing channel. The marketing channel is at least one of Google, Facebook, Bing, Twitter, Linkedn and the like.

According to an embodiment herein, the application tool enables a user to determine if one or more advertisements are active or not, determine a location where the advertisements are displayed, view the performance of the advertisement campaigns anytime on any portal irrespective of the web page being surfed on the browser and make modifications to the advertisement characteristics without going to the advertising portal.

According to an embodiment herein, the method also includes monitoring advertisement characteristics of one or more advertisements, informing the user of any recommended changes related to the advertisements and alerting the user to take action in response to the recommended changes.

The embodiments herein further provide a system for managing online paid advertisements comprises an application server, one or more user devices in communication with the application server and an advertisement management application tool installed on a web browser on the one or more user devices. The application tool is adapted for enabling the user to directly review and edit one or more advertisements displayed on the browser of the user device, modifying a plurality of advertisement details, a plurality of display characteristics and additional information related to the advertisement on obtaining suggestions for an advertisement, creating one or more new advertisements including attractive vocabularies, attractive slides, and multilingual information, multicasting the advertisements over frequently visited websites and providing a plurality of the other suggestions pertaining with the advertisement details and the advertisement performance details.

According to an embodiment herein, the application tool is further adapted for facilitating one or more third party users to providing suggestions on the advertisements posted by the user and managing online paid advertisements comprises a task bar displayed on the web browser of the user device.

According to an embodiment herein, the task bar comprises of one or more advertisement account details, a calendar, one or more advertisement performance details, a ticker bar and one or more graphical details for the advertisements.

According to an embodiment herein, the application server comprises an advertisement management application database to store the user details and the advertisement details and a Business Intelligence Engine (BIE) to track the performance of each of the plurality of advertisements and to provide a plurality of advertisement oriented suggestions to the user.

According to an embodiment herein, the one or more user devices is connected to the application server through a communication network. The communication network is at least one of a wired network or a wireless network and the user device is one of smart phone device, a PC, PDA and a laptop.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a flowchart illustrating a method for managing an online advertisement for a single user account, according to an embodiment herein.

FIG. 2 is a flowchart illustrating a method for managing multiple online advertisements according to another embodiment herein.

FIG. 3 is a block diagram illustrating a system for managing online advertisements, according to an embodiment herein.

FIG. 4 is a scenario diagram illustrating an application tool displayed on a task bar of the web browser for managing a plurality of online advertisements according to an embodiment herein.

FIG. 5 is a scenario diagram illustrating a plurality of alerts provided through an online advertisement management application task bar, according to an embodiment herein.

FIG. 6 is a scenario diagram illustrating a plurality of account details provided through an online advertisement management application task bar, according to an embodiment herein.

FIG. 7 is a scenario diagram illustrating performance details of a plurality of advertisements displayed through the advertisement management application task bar, according to an embodiment herein.

FIG. 8 is a scenario diagram illustrating a plurality of user preferences for managing a searched advertisement, according to an embodiment herein.

FIG. 9 is a scenario diagram illustrating a plurality of user preferred attributes for managing the bidding details of the online advertisements, according to an embodiment herein.

FIG. 10 is a scenario diagram illustrating a plurality of user preferences to manage the display details for the bid value of the online advertisements, according to an embodiment herein.

FIG. 11 is a scenario diagram illustrating a plurality of user preferences for the search results of the online advertisements, according to an embodiment herein.

FIG. 12 is a scenario diagram illustrating a plurality of details for the online advertisements, according to an embodiment herein.

FIG. 13 is a scenario diagram illustrating a plurality of user preferences for editing the details of the online advertisements, according to an embodiment herein.

Although the specific features of the present disclosure are shown in some drawings and not in others. This is done for convenience only as each feature may be combined with any or all of the other features in accordance with the present disclosure.

### DETAILED DESCRIPTION OF THE DRAWINGS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments of herein provide a method and system for managing a plurality of online paid advertisements. The method of managing advertisements comprises steps of registering a plurality of users for an advertisement management application, retrieving information on one or more advertisements from the user, downloading an application tool from an application server and installing the application tool on a user device. The method further comprises accessing one or more advertisement accounts of at least one user, displaying a plurality of details of the one or more advertisements, providing a plurality of suggestions for the one or more advertisements and performing one or more actions on the advertisements from the plurality of suggestions based on a user requirement. The one or more actions includes creating new advertisements, modifying display characteristics of the existing advertisements, reviewing performance details of the advertisement, modifying the advertisement content and modifying the advertisement characteristics according to the suggestions.

The method of registering the plurality of users comprises steps of providing a plurality of user credentials, creating a log-in account, providing details of existing advertisement accounts and creating a new advertisement account with at least one marketing channel. The user credentials include a name of the user, an email id and a password for authenticating the user onto the application server. The user is at least one of a user owning a single advertisement account, a user owning multiple advertisement accounts or an enterprise owning multiple advertisement accounts. Here the plurality of advertisements includes at least one of Google Adwords, Facebook Ads, Bing Adcenter, LinkedIn Ads, Twitter Ads and Display Ad Networks, where the advertisements is in the form of graphical ads comprising banner ads, text only ads, image ads, video ads, audio ads and a combination thereof.

The application tool as disclosed herein is one of a plug-in tool adapted to be installed on any web browser on the user device or any application installed in the user device. The plurality of details of the online advertisement is displayed in the form of a task bar provided by the application tool. The plurality of details of the online paid advertisement is at least one of an advertisement name, number of clicks and performance of the advertisement.

The plurality of suggestions provided by the application tool comprises at least one of modification of advertisement details, modification of advertisement display characteristics, inclusion of additional information for the advertisements, inclusion of new advertisements, inclusion of attractive vocabularies, inclusion of attractive slides, inclusion of multilingual information, multicasting the advertisements over frequently visited websites, payment options for the user and a plurality of the other suggestions pertaining to the advertisement details and the performance details.

The method of managing a plurality of online advertisements further comprises registering one or more third party users with the application server, obtaining one or more suggestions from the third party users to enhance the performance of the advertisements and modifying a plurality of advertisement details, a plurality of display characteristics and additional information related to the advertisements by the user based on the suggestions. The display characteristics comprises display color, intensity of the display color, slide show of the advertisement display, display area for the advertisement and a plurality of display modifying options depending upon the user's preferences.

The method of managing the plurality of advertisements using the application tool comprises logging onto the application server, requesting an access to one or more advertisement accounts of at least one user, accessing a plurality of ad accounts by authorizing a corresponding marketing channel, displaying a plurality of details of an online paid advertisement and displaying an alert for newly obtained suggestions from one or more third party individuals. Also the plurality of details of the online paid advertisement is displayed in the form of a task bar provided by the application tool, the method also includes monitoring advertisement characteristics of one or more advertisements, informing the user of any recommended changes related to the advertisements and alerting the user to take action in response to the recommended changes.

The plurality of user accounts is created in at least one marketing channel. The marketing channel is at least one of Google, Facebook, Bing, Twitter, LinkedIn and the like.

The system for managing online paid advertisements comprises an application server, one or more user devices in communication with the application server and an advertisement management application tool installed on a web browser on the one or more user devices. The application tool is adapted for enabling the user to directly review and edit one or more advertisements displayed on the browser of the user device, modifying a plurality of advertisement details, a plurality of display characteristics and additional information related to the advertisement on obtaining suggestions for an advertisement, creating one or more new advertisements including attractive vocabularies, attractive slides, and multilingual information, multicasting the advertisements over frequently visited websites and providing a plurality of the other suggestions pertaining with the advertisement details and the advertisement performance details.

The application tool is further adapted for facilitating one or more third party users to providing suggestions on the advertisements posted by the user and managing online paid advertisements comprises a task bar displayed on the web browser of the user device.

The task bar comprises of one or more advertisement account details, a calendar, one or more advertisement performance details, a ticker bar and one or more graphical details for the advertisements.

The application server comprises an advertisement management application database to store the user details and the advertisement details and a Business Intelligence Engine (BIE) to track the performance of each of the plurality of advertisements and to provide a plurality of advertisement oriented suggestions to the user.

The application tool enables a user to determine if one or more advertisements are active or not, determine a location where the advertisements are displayed, view the performance of the advertisement campaigns anytime on any portal irrespective of the web page being surfed on the browser and make modifications to the advertisement characteristics without going to the advertising portal. Also the application tool facilitates one or more third party individuals to send requests to the user for becoming a commercial adviser for the advertisements posted by the user. One or more third party individuals form a crowd in which, each one sign-up as a “Reviewer” into the application server for providing suggestions for the advertisements posted by the user.

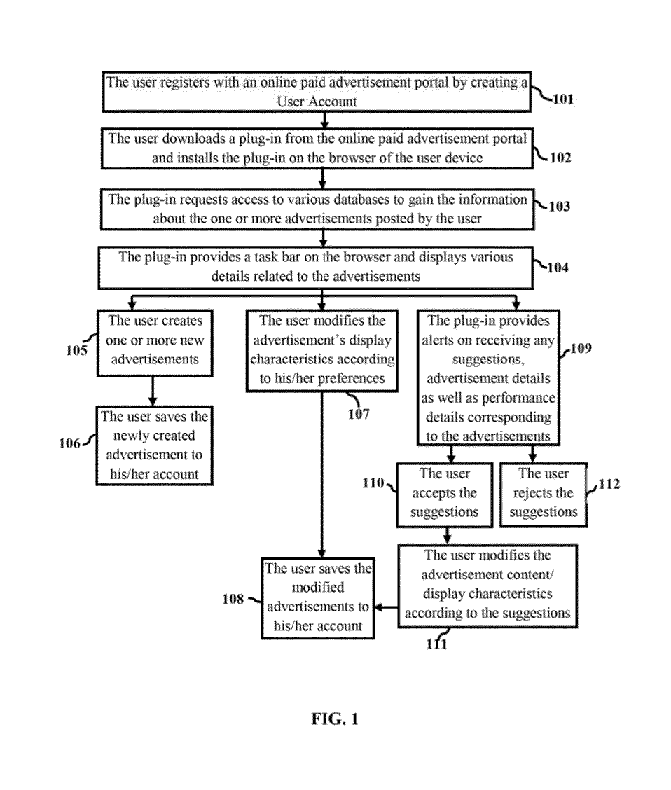

FIG. 1 is a flowchart illustrating a method for managing an online paid advertisement for a single user account, according to an embodiment herein. The user creates a login account and registers with an online paid advertisement portal 101. The application server authenticates the user to download an online advertisement management application. Here the application is a plug-in tool which is adapted to be installed on any web browser. The user downloads the plug-in and installs the plug-in on the browser of the user device 102. The plug-in requests the access to various databases during installation process, for gaining the information about the one or more advertisements posted by the user 103. On successful installation, the plug-in provided as a task bar on the browser. The task bar displays various details related to the advertisements 104. Alternatively, the plug-in can also be provided as an application on the user device.

The plug-in facilitates the user to create one or more new advertisements according to user's preferences 105. The user enters a plurality of advertisements into the plug-in like display color, intensity of the display color, slide show of the advertisements display, display area for the advertisement etc. The user saves the advertisements details for the newly created advertisement to his/her account 106.

The plug-in facilitates the user to modify the display characteristics of the existing advertisements according to his/her preferences 107 and save the modified advertisements to his/her account. The display characteristics comprise display color, intensity of the display color, slide show of the advertisements display and display area for the advertisement. The display characteristics further comprise a plurality of display modifying options depending upon the user's preferences.

The plug-in provides alerts on receiving any suggestions, advertisement details as well as performance details corresponding to the advertisements corresponding to the advertisements 109. When the user accepts the suggestions 110 the plug-in further facilitates the user to modify the advertisement content and display characteristics according to the suggestions 111. When the user rejects the suggestions 112, the plug-in redirects the user back to the alerts page.

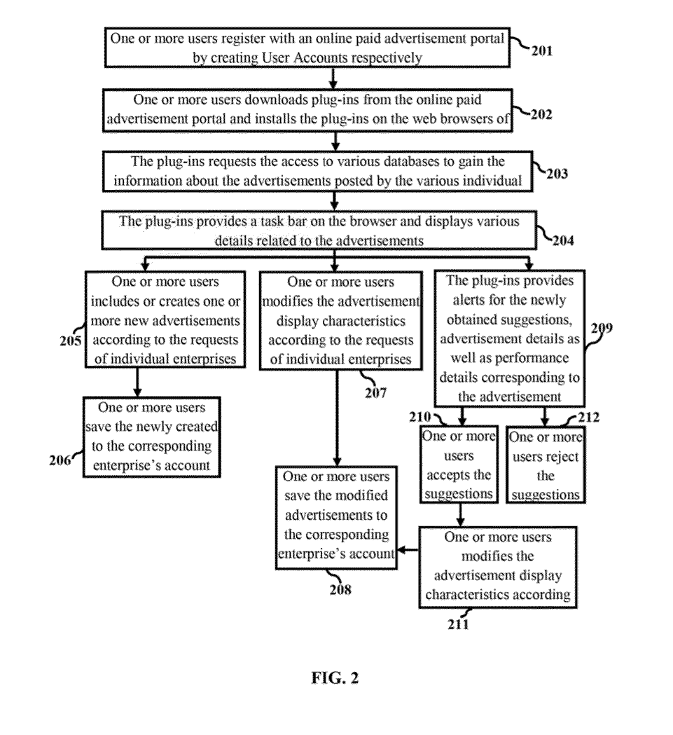

FIG. 2 is a flowchart illustrating a method for managing multiple online paid advertisements, according to another embodiment herein. The user (an advertiser/an agency) creates one or more login accounts on the application server 201. The application server authenticates the user to download the plug-in. The user downloads the plug-in from the online paid advertisement portal and installs the plug-in on the browser of the application on the respective user devices 202. The plug-in requests the access to various databases during installation process, for gaining the information about the one or more advertisements posted by various individuals 203. The plug-in provides a task bar on the browser of the user device after successful installation. The task bar displays various details related to the advertisements 204.

The plug-in facilitates the users to create one or more new advertisements according to the request of individual enterprises 205. The user provides various preferences details like display color, intensity of the display color, slide show of the advertisements display, display area for the advertisement etc. The users the save the advertisements newly created advertisements along with the advertisement details to the corresponding enterprise account 206.

The plug-in facilitates the third party enterprise to modify the display characteristics of the existing advertisements according to the request of the individual enterprises 207 and save the modified advertisements to the corresponding enterprise account 208. The display characteristics comprise display color, intensity of the display color, slide show of the advertisements display and display area for the advertisement. The display characteristics further comprise a plurality of display modifying options depending upon the users' preferences.

The plug-in provides alerts on receiving any new suggestions, advertisement details as well as performance details corresponding to the advertisements 209. When the user accepts the suggestions 210, the plug-in further facilitates the user to modify the advertisement content and display characteristics according to the suggestions 211. When the user rejects the suggestions 212, the plug-in redirects the user back to the alerts page.

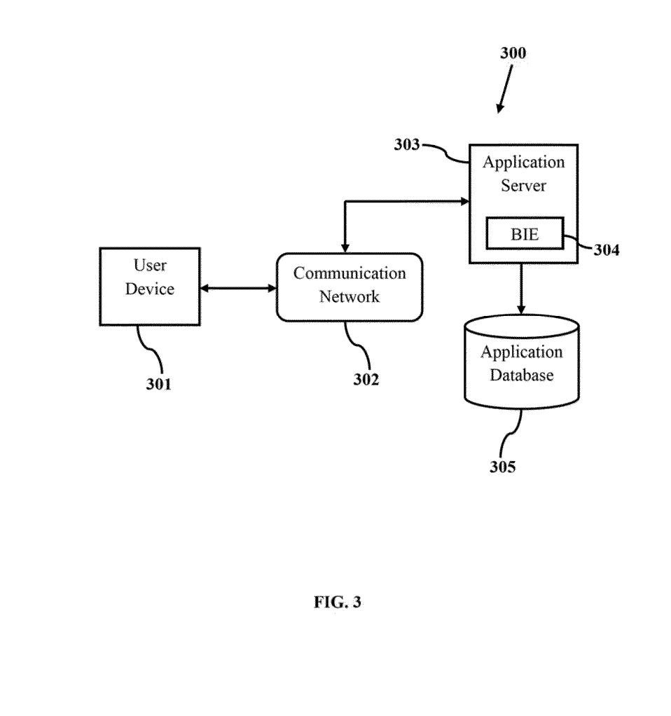

FIG. 3 is a block diagram illustrating a system for managing online paid advertisements, according to an embodiment herein. The system for management of an online paid advertisement comprises a user device 301, a communication network 302, an application server 303 and an advertisement management application database 305. The application server 303 further comprises a Business Intelligence Engine (BIE) 304. The user device 301 is connected to the application server 303 via the communication network 302. The communication network 302 can be a wired network or a wireless network. The user creates a login ID and a password in the application server 303 through the user device 301. The login ID and the password of the user are stored in the advertisement management application database 305. The user downloads and installs the tool for management of the online paid advertisements on the user device 301. The tool provides a task bar on the screen of the user device 301. The task bar provides a plurality of advertisement details as well as performance details to the user via the user device 301. The user accesses the plurality of advertisement details as well as the performance details by providing an authenticated login ID and password. The performances details displayed on the user device 301 screen are managed through the BIE 304. The BIE also provides a plurality of advertisement oriented suggestions to the user.

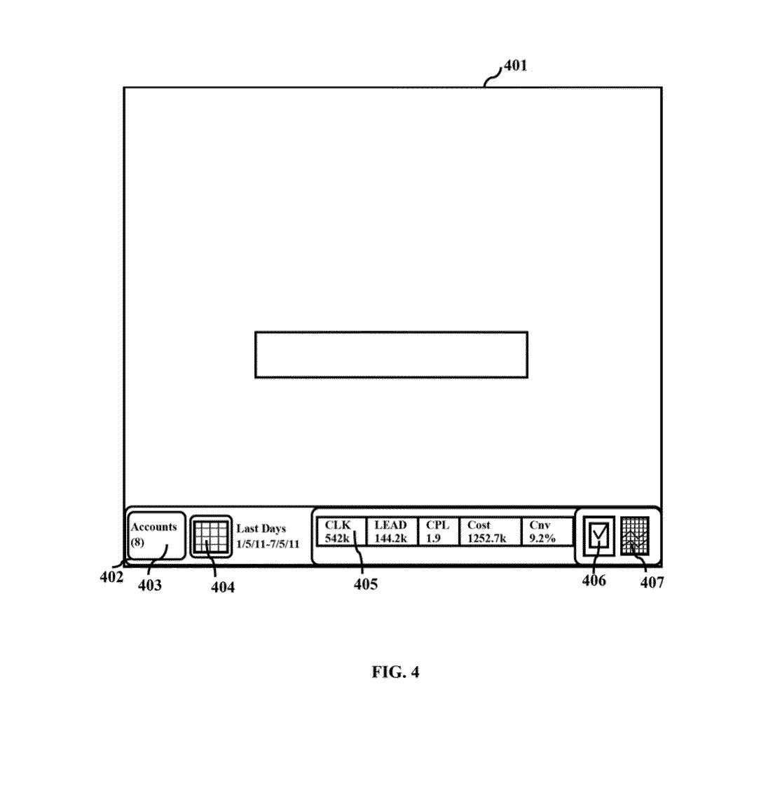

FIG. 4 is a schematic diagram illustrating an application tool displayed on a task bar of the web browser for managing a plurality of online advertisements according to an embodiment herein. The application tool for managing online paid advertisements comprises a task bar 402 which is displayed on the browser of the user device interface 401. The task bar 402 comprises one or more account details 403, a calendar 404, one or more performance details 405, a ticker bar 406 and one or more graphical details for the advertisements 407. The account details 403 comprise a plurality of accounts and specific details of the advertisements related to the corresponding accounts. The task bar 402 facilitates the user to view the performance details of his/her advertisements over a selected period. The user selects the period of performance through the calendar 404 provided on the task bar 402. The task bar further caters the plurality of performance details 405 which include performances fields like sales of advertised products (SLS), clicks on advertisements (CLK), leads for the advertisements by the third party individual (LEAD), cost per lead (CPL), spends (COST) i.e. expenditure for the advertisement, conversion (CNV) i.e. modification of the advertisement, click through rate (CLK) i.e. rate of the clicks for the advertisements, application clicks (SCLK) i.e. clicks by the users registered through the Application database and Application Leads (SLED) i.e. leads for the advertisements viewed by the users registered through the Application database.

The task bar further provides a ticker bar 406. The ticker bar 406 provides a select option for each performance fields. When the user selects a performance field by checking the box corresponding to a performance field, then the selected performance field is displayed on the task bar 402.

The task bar also provides one or more graphical details for the advertisements 407. The graphical details 407 provide a graphical representation for the details of one more performance fields. The graphical details 407 also facilitate a comparison among two or performance fields in a graphical mode.

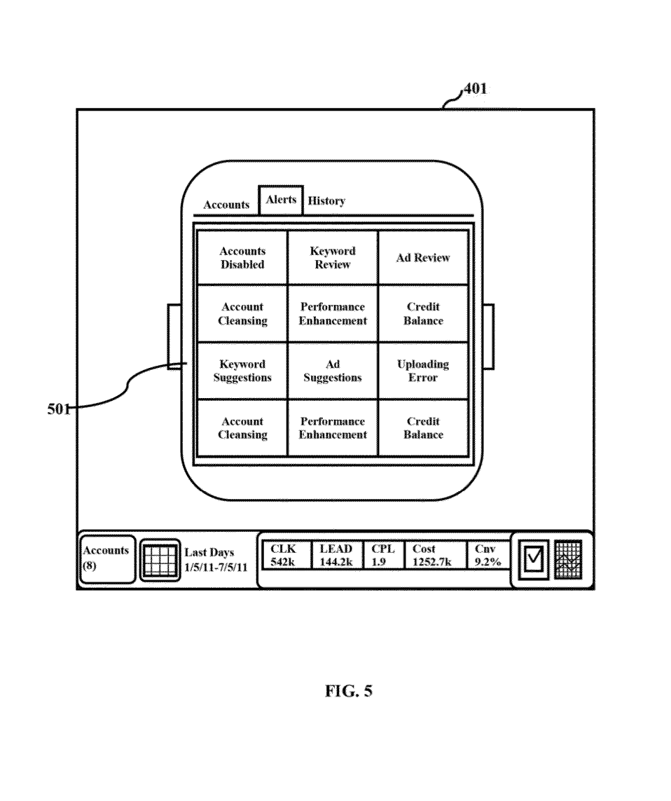

FIG. 5 is a scenario diagram illustrating a plurality of alerts provided through an online paid advertisement management application task bar, according to an embodiment herein. The advertisement management application provides one or more alerts 501 related to an advertisement or a plurality of advertisements. The application provides an alert 501 window on a user interface 401. The alert window 501 includes alerts for the disabled accounts, the reviewed keywords, the reviewed adwords and the number of account deleted. The alert window 501 further includes alerts for credit balance for corresponding account, keywords suggested during modifying, editing or adding the advertisement details. The alert window 501 also includes the alerts for the number of times an error has occurred while uploading the advertisements.

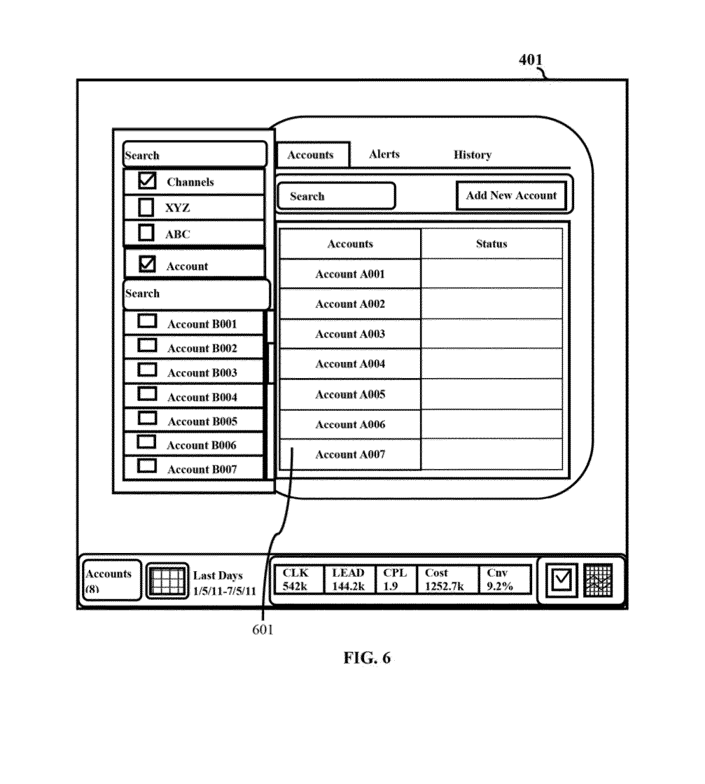

FIG. 6 is a scenario diagram illustrating a plurality of account details provided through an online paid advertisement management application task bar, according to an embodiment herein. The application tool provides an account window 601 on the user interface 401. The account window 601 facilitates the user to view the details of one or more user accounts. One or more user accounts consists the accounts created by the user over a plurality of advertisements databases. The details of one or more account comprise status of the corresponding accounts. The status of the corresponding accounts includes disabled account, successfully linked accounts and status of an ongoing linking for an account.

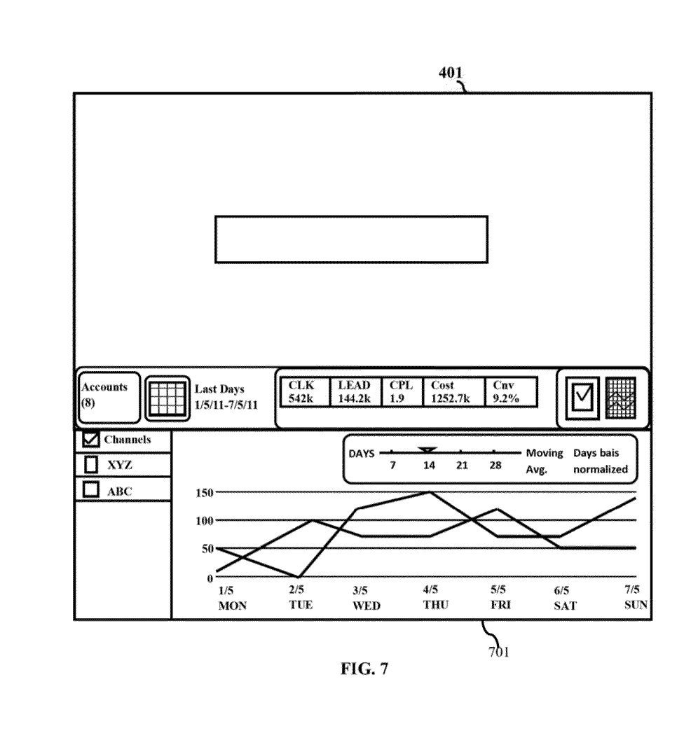

FIG. 7 is a scenario diagram illustrating performance details of a plurality of advertisements displayed through the advertisement management application task bar, according to an embodiment herein. The application tool displays a graphical representation 701 of the performance details of tone or more advertisements over the user interface 401. The graphical representation 701 of the performance details further comprises performance details of an advertisement over a selected period. The graphical representation 701 of the performance details also comprises comparison graph for two or more performance fields of two or more advertisements.

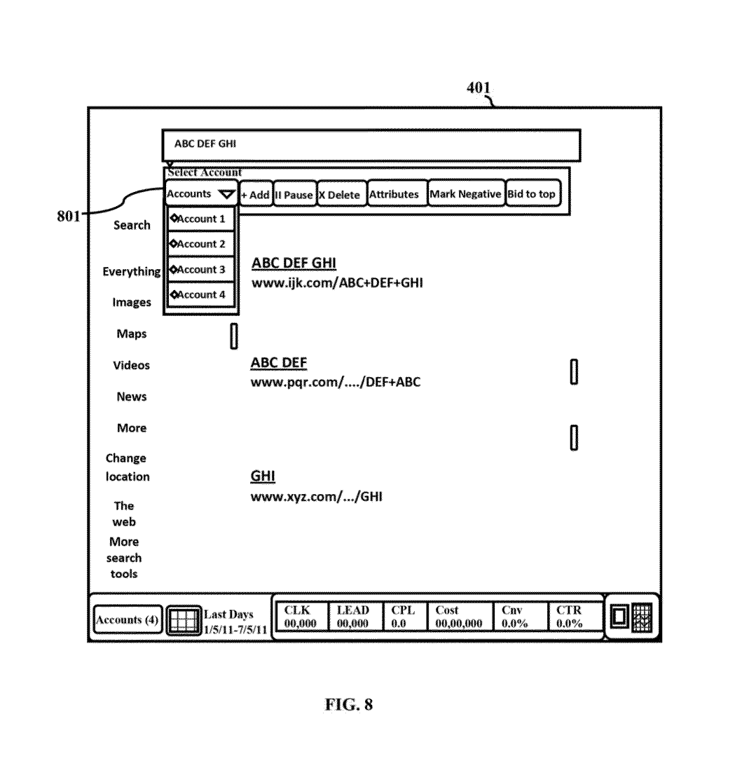

FIG. 8 is a scenario diagram illustrating a plurality of user preferences for managing a searched advertisement, according to an embodiment herein. With respect to FIG. 8, the pluralities of the user preferences 801 for managing the searched advertisement are displayed on a page of the web browser 401. The pluralities of the user preferences 801 facilitate a user to select a managed account for the searched advertisement. The pluralities of the user preferences 801 further facilitates the user to add, pause or delete a search criterion for the managed advertisement. The pluralities of the user preferences 801 furthermore facilitate the user to mark a bid value for a managed advertisement as “negative”.

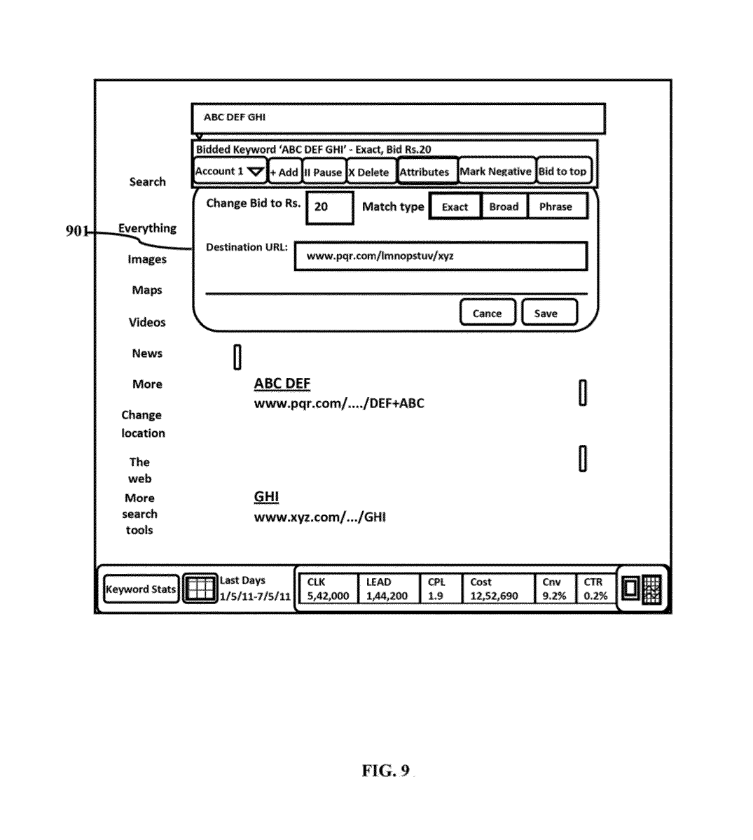

FIG. 9 is a scenario diagram illustrating a plurality of user preferred attributes for managing the bidding details of the online paid advertisements, according to an embodiment herein. With respect to FIG. 9, the user preferred attributes 901 are displayed on a page of the user interface 401. The user preferred attributes 901 comprises addition of a bid value for an advertisement, selecting a search criterion for the added bid value and display a destination URL for the advertisement whose bid value is added.

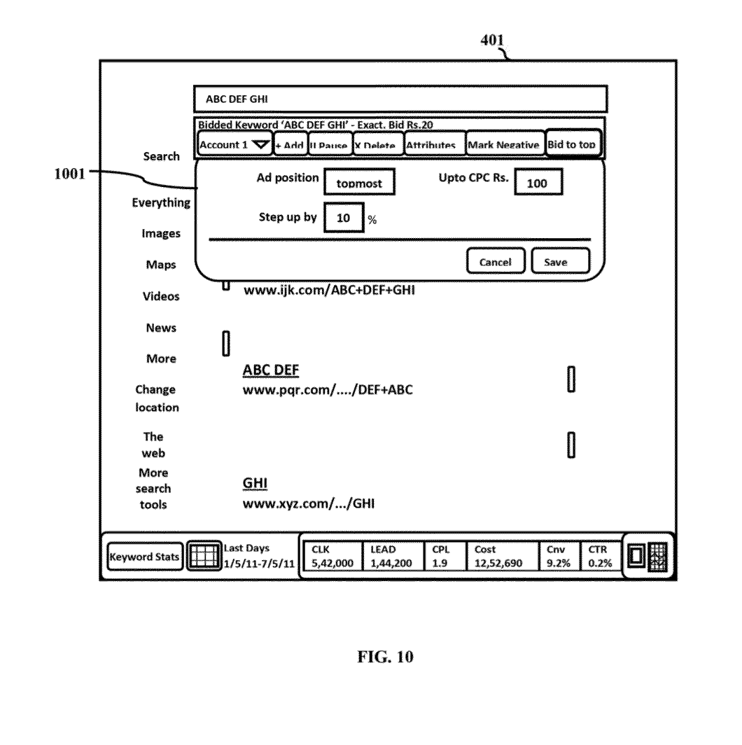

FIG. 10 is a scenario diagram illustrating a plurality of user preferences to manage the display details for the bid value of the online paid advertisement, according to an embodiment herein. With respect to FIG. 10, the pluralities of user preferences 1001 to manage the display details for the bid value of an advertisement are displayed over a page of the web browser 401. The pluralities of user preferences 1001 further comprise a select criterion for positioning a bid value over a page of the user interface 401. The pluralities of user preferences 1001 furthermore comprise a field for selecting a maximum cost per click (CPC) value and a field for selecting a maximum permissible increment in the bid value.

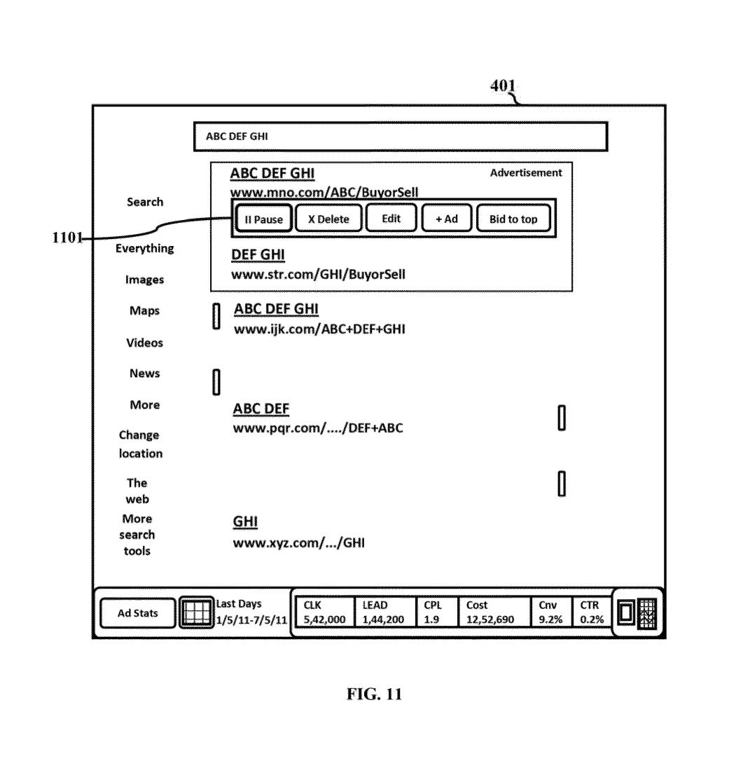

FIG. 11 is a scenario diagram illustrating a plurality of user preferences for the search results of the online paid advertisement, according to an embodiment herein. The pluralities of user preferences 1101 for the search results are displayed over a page of the user interface 401. The pluralities of user preferences 1101 for the search results comprise a select criterion for adding, deleting, pausing and marking a bid value for a searched advertisement. The searched advertisement occurs when a user enters a keyword related to a managed advertisement in a search field.

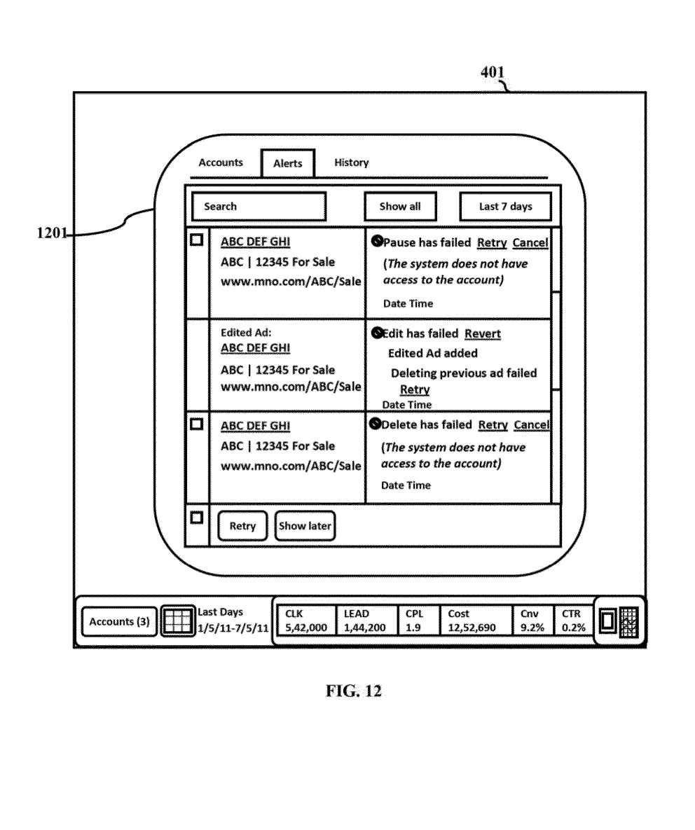

FIG. 12 is a scenario diagram illustrating a plurality of details for the advertisements managed through the system and method for managing an online paid advertisement, according to an embodiment herein. The pluralities of details 1201 for the managed advertisements are displayed over a page of the user interface 401. The pluralities of details 1201 comprises the URL details of the managed advertisement and progress details of the actions performed for the managed advertisements.

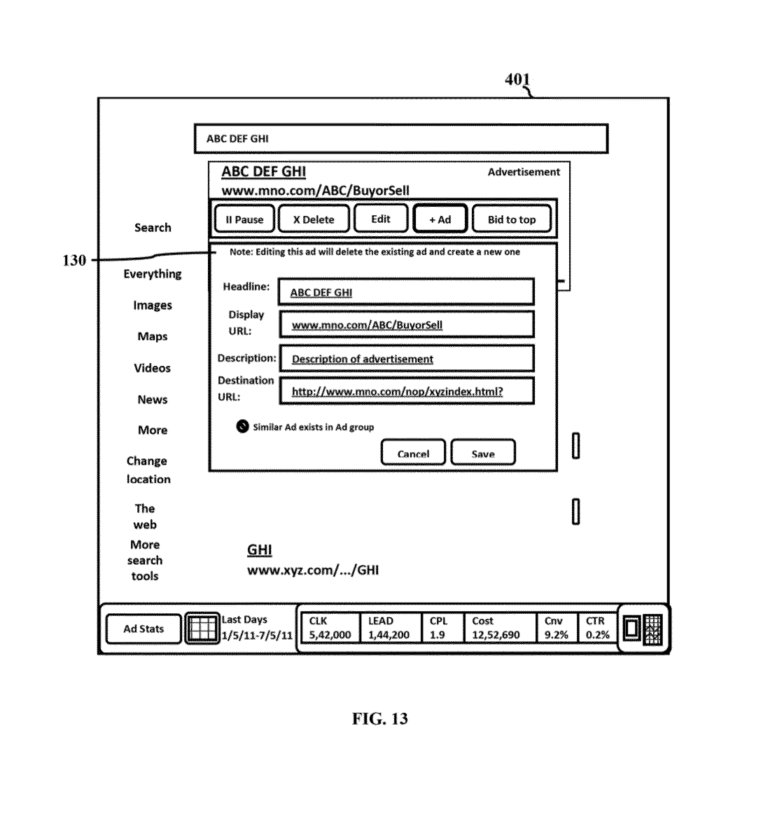

FIG. 13 is a scenario diagram illustrating a plurality of user preferences for editing the details of an advertisement managed through the system and method for managing an online paid advertisement, according to an embodiment herein. The pluralities of user preferences 1301 for editing the details of the advertisement are displayed over a page of the browser on the user device interface 401. The pluralities of the user preferences 1301 comprise a headline for the managed advertisement, a display URL for the managed advertisement, a description field for the managed advertisement and a destination URL.

The embodiments herein enable a user to actually search for his ad unit and see the place where it is “live”. Further, the user can see the performance/attributes of the campaigns on any portal at any time on the tool bar, which can be browser based or application based, irrespective of what page is being surfed on in the browser. The toolbar herein is WYSIWIG (What you see is what you get), i.e any modifications made to the ad characteristics will directly be deposited to the advertising portal without going to the advertising portal itself.

The business intelligence engine as disclosed herein continuously monitors and proactively prompt the user of any recommended changes or alerts that user is aware of and should possibly take an action.

The method and system for management of an online paid advertisement facilitates the users a smooth navigation through the advertisements, provides a simplified advertisement account management structure, provides a plurality of the performance details through which the user assesses the workability of the existing advertisements and provides performance enhancing suggestions for the existing advertisements to the user.

The application tool as disclosed herein for managing online advertisements is compatible with a plurality of the end devices like PCs, laptops, smart phones etc. The application tool provides suggestions on the browser without the need for user to leave his current page or go to any channel-specific interface. Further the application tool also enables the user to view the relative performance of the current ad in comparison to other ads instead of going to individual channel interface.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the disclosure with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between.

What is claimed is:

1. A method of managing a plurality of advertisements, the method comprising steps of:
registering a plurality of users for an advertisement management application;
retrieving information on one or more advertisements from the user;
downloading an application tool from an application server;
installing the application tool on a user device;
accessing one or more advertisement accounts of at least one user;
displaying a plurality of details of the one or more advertisements;
providing a plurality of suggestions for the one or more advertisements; and
performing one or more actions on the advertisements from the plurality of suggestions based on a user requirement;
wherein the one or more actions includes creating new advertisements, modifying display characteristics of the existing advertisements, reviewing performance details of the advertisement, modifying the advertisement content and modifying the advertisement characteristics according to the suggestions.

2. The method of claim 1, wherein registering to an application server comprising steps of:
providing a plurality of user credentials,
creating a log-in account;
providing details of existing advertisement accounts; and
creating a new advertisement account with at least one marketing channel;
wherein the user credentials include a name of the user, an email id and a password for authenticating the user onto the application server.

3. The method of claim 1, wherein the user is at least one of a user owning a single advertisement account, a user owning multiple advertisement accounts or an enterprise owning multiple advertisement accounts.

4. The method of claim 1, wherein the plurality of advertisements comprises at least one of Google Adwords, Facebook Ads, Bing Adcenter, LinkedIn Ads, Twitter Ads and Display Ad Networks, where the advertisements is in the form of graphical ads comprising banner ads, text only ads, image ads, video ads, audio ads and a combination thereof.

5. The method of claim 1, wherein the application tool is one of a plug-in tool adapted to be installed on any web browser on the user device or any application installed in the user device.

6. The method of claim 1, wherein the plurality of details of the online paid advertisement is displayed in the form of a task bar provided by the application tool, where the plurality of details of the online paid advertisement is at least one of an advertisement name, number of clicks and performance of the advertisement.

7. The method of claim 1, wherein the plurality of suggestions provided by the application tool comprises at least one of:
modification of advertisement details;
modification of advertisement display characteristics;
inclusion of additional information for the advertisements;
inclusion of new advertisements;
inclusion of attractive vocabularies, inclusion of attractive slides;
inclusion of multilingual information;
multicasting the advertisements over frequently visited websites;
payment options for the user; and
a plurality of the other suggestions pertaining to the advertisement details and the performance details.

8. The method of claim 1, further comprising steps of:
registering one or more third party users with the application server;
obtaining one or more suggestions from the third party users to enhance the performance of the advertisements; and
modifying a plurality of advertisement details, a plurality of display characteristics and additional information related to the advertisement by the user based on the suggestions.

9. The method of claim 8, wherein the display characteristics comprises display color, intensity of the display color, slide show of the advertisement display, display area for the advertisement and a plurality of display modifying options depending upon the user's preferences.

10. The method of claim 1, wherein managing the plurality of advertisements using the application tool comprising steps of:
logging onto the application server,
requesting an access to one or more advertisement accounts of at least one user,
wherein the plurality of user accounts are created in at least one marketing channel;
accessing a plurality of ad accounts by authorizing a corresponding marketing channel;
displaying a plurality of details of an online paid advertisement; and
displaying an alert for newly obtained suggestions from one or more third party individuals;
wherein the plurality of details of the online paid advertisement is displayed in the form of a task bar provided by the application tool.

11. The method of claim 10, wherein the marketing channel is at least one of Google, Facebook, Bing, Twitter, LinkedIn and the like.

12. The method of claim 1, wherein the application tool enables a user to:
determine if one or more advertisements are active or not;
determine a location where the advertisements are displayed;
view the performance of the advertisement campaigns anytime on any portal irrespective of the web page being surfed on the browser; and
make modifications to the advertisement characteristics without going to the advertising portal.

13. The method of claim 1 further comprising steps of:
monitoring advertisement characteristics of one or more advertisements;
informing the user of any recommended changes related to the advertisements; and
alerting the user to take action in response to the recommended changes.

14. A system for managing online paid advertisements comprises:
an application server;
one or more user devices in communication with the application server;
an advertisement management application tool installed on a web browser on the one or more user devices, wherein the application tool is adapted for:
enabling the user to directly review and edit one or more advertisements displayed on the browser of the user device;
modifying a plurality of advertisement details, a plurality of display characteristics and additional information related to the advertisement on obtaining suggestions for an advertisement;
creating one or more new advertisements including attractive vocabularies, attractive slides, and multilingual information, multicasting the advertisements over frequently visited websites; and
providing a plurality of the other suggestions pertaining with the advertisement details and the advertisement performance details.

15. The system of claim 14, wherein the application tool is further adapted for facilitating one or more third party users to providing suggestions on the advertisements posted by the user.

16. The system of claim 14, wherein the application tool for managing online paid advertisements comprises a task bar displayed on the web browser of the user device.

17. The system of claim 16, wherein the task bar comprises at least one of:
one or more advertisement account details,
a calendar,
one or more advertisement performance details,
a ticker bar; and
one or more graphical details for the advertisements.

18. The system of claim 14, wherein the application server comprises:
an advertisement management application database to store the user details and the advertisement details; and
a Business Intelligence Engine (BIE) to track the performance of each of the plurality of advertisements and to provide a plurality of advertisement oriented suggestions to the user.

19. The system of claim 14, wherein the user device is at least one of smart phone device, a PC, PDA and a laptop.

20. The system of claim 14, wherein the one or more user devices is connected to the application server through a communication network, where the communication network is at least one of a wired network or a wireless network.
